(19) United States
(12) Patent Application Publication
(10) Pub. No.: US 2015/0278933 A1
(43) Pub. Date: Oct. 1, 2015

(54) PROVIDING AND USING VEHICLE LOCATION INFORMATION DURING AUCTIONS

(71) Applicant: HTI IP, LLC, Arlington, VA (US)

(72) Inventor: James Ronald Barfield, Jr, Atlanta, GA (US)

(73) Assignee: HTI IP, LLC, Arlington, VA (US)

(21) Appl. No.: 14/226,529

(22) Filed: Mar. 26, 2014

(51) Int. Cl. G06Q 30/08

(52) U.S. Cl. CPC G06Q 30/08

(57) ABSTRACT

An “in-vehicle device” may provide location information relating to one or more vehicles in which the in-vehicle device is installed. The location information may be used to track the location of vehicles in a vehicle dealership or auction facility. In one implementation, the location of vehicles may be used, during a vehicle auction, to provide prospective bidders with real-time information relating to the location of a vehicle and the estimated auction time of the vehicle. In other implementations, the in-vehicle device may provide sensor data, such as audio or acceleration data, relating to the vehicle. The sensor data may be used to detect abnormal operating conditions of the vehicle.

### BACKGROUND

The term “On-Board Diagnostics” (OBD) refers to a computer-based monitoring system built into vehicles. For example, in the United States, model year 1996 and newer light-duty cars and trucks include an OBD system that uses the standardized OBD-II interface. The OBD system may monitor the performance of some of an engine's components.

In vehicles that include OBD systems, an OBD port may allow external devices (“OBD devices”) to be connected to and communicate with the OBD systems. The OBD devices may receive power from the OBD port of the vehicle, thus allowing the devices to be mounted in a relatively permanent manner within the vehicle (e.g. by using an OBD-II connector). The OBD devices may include a wireless transceiver to connect, for example, to a cellular wireless network, which may allow the OBD devices to transmit information relating to the operation of the vehicle. Some existing OBD devices may be used, for example, to monitor driving patterns for use in determining whether the driver is eligible for an insurance discount.

### BRIEF DESCRIPTION OF THE DRAWINGS

FIGS. 1A-1C are diagrams illustrating an example of an overview of concepts described herein.

FIG. 2 is a diagram illustrating an example environment in which systems and/or methods described herein may be implemented.

FIG. 3 is a block diagram conceptually illustrating an example of components that may be included within a device installed in a vehicle;

FIGS. 4 and 5 are flowcharts illustrating example processes relating to facilitating vehicle auctions at a dealership;

FIGS. 6A and 6B are diagrams illustrating an example of graphical interfaces, such as an interface provided by a mobile device;

FIGS. 7 and 8 are diagrams illustrating example data structures, such as data structures that may be maintained by a remote server and may relate to the analysis of audio data;

FIGS. 9 and 10 are flowcharts illustrating example processes, respectively, relating to analysis of vehicle audio data;

FIG. 11 is a diagram illustrating an example data structure that may be maintained by a remote server and that relates to the analysis of acceleration data; and

FIGS. 12 and 13 are flowcharts illustrating example processes relating to analysis of vehicle acceleration data;

FIG. 14 is a diagram illustrating an example of a mesh network that may be created by in-vehicle devices that are installed in vehicles; and

FIG. 15 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques described herein may provide for a device, called an “in-vehicle device” herein, that may be installed in vehicles, and that may wirelessly provide information to one or more server devices. For example, the in-vehicle device may be installed as part of the manufacture of the vehicle or by a dealership (or other entity) that obtains the vehicle for sale to an end-user. The information provided by the in-vehicle device may be used to track the location of the vehicle by the dealership. In one implementation, the location of vehicles may be used, during a vehicle auction, to provide prospective bidders with real-time information relating to the location of a vehicle and the estimated auction time of the vehicle.

In some implementations, the in-vehicle device may include sensors that may provide additional information, such as diagnostic information, relating to the operation and performance of the vehicle (e.g. using information through protocol specified by SAE or ISO standards). For example, the in-vehicle device may include a microphone. Audio data obtained through the microphone, such as audio data recording sounds of the vehicle's engine, may be analyzed, such as based on a comparison of the vehicle's engine sounds relative to “normal” engine sounds corresponding to the make and model of the vehicle. Results relating to the analysis, such as an indication of whether vehicle engine sounds are abnormal, may be provided to the dealership and/or to prospective buyers of the vehicle.

As another example, the in-vehicle device may include an accelerometer. Acceleration data may be captured by the in-vehicle device while the vehicle is accelerating, such as acceleration that occurs when the vehicle is driven on a standard test track. Acceleration data may be analyzed and results relating to the analysis, such as an indication of whether acceleration patterns of the vehicle are abnormal for the particular make and model of the vehicle, may be provided to the dealership and/or to prospective buyers of the vehicle. In some implementations, other information, such as information provided by the vehicle, and to the in-vehicle device, via the OBD port of the vehicle, may also be used in the analysis of the audio or acceleration data, and/or may be provided to the dealership and/or to the prospective buyers of the vehicle. Furthermore, the OBD device may obtain vehicle diagnostics information to provide perspective buyers of the diagnostic condition of the vehicle.

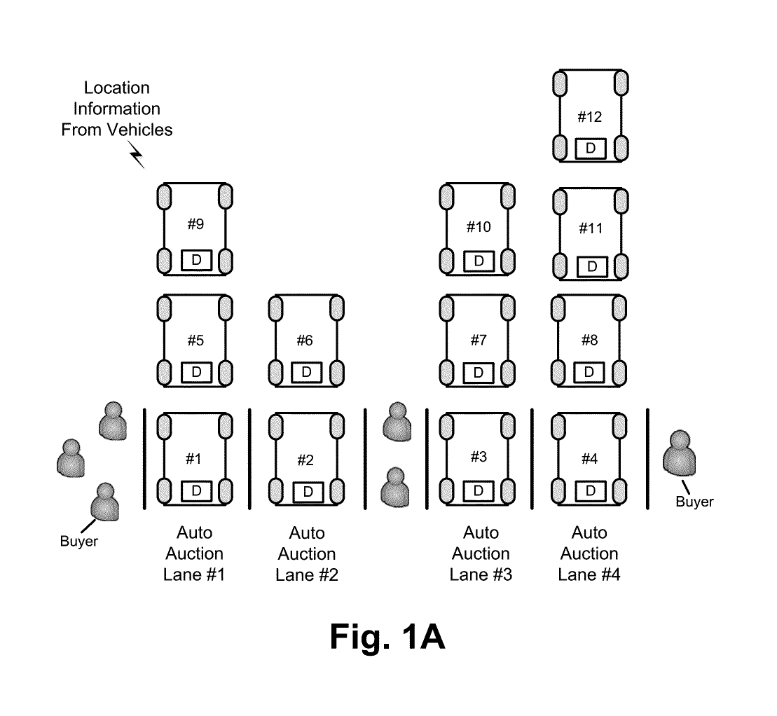

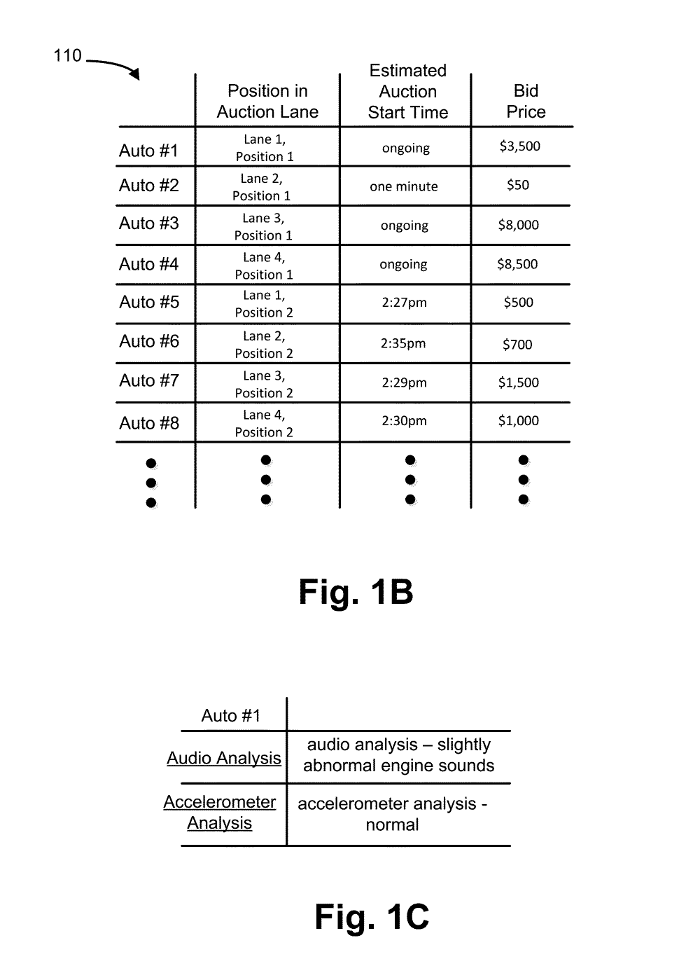

FIGS. 1A-1C are diagrams illustrating an example of an overview of concepts described herein.

In the example of FIG. 1A, assume that an automobile dealership is holding a vehicle auction. The auction may include a number of vehicles that are contemporaneously being auctioned. In this example, four vehicles may potentially be up for auction (i.e., vehicles for which bidding is open) at any particular time. The vehicles for sale may be queued in individual auction lanes (labeled as Auction Lane #1, Auction Lane #2, Auction Lane #3, and Auction Lane #4). The vehicle at the head of each auction lane may be the vehicle that is currently being auctioned. In FIG. 1A, the vehicles labeled #1, #2, #3, and #4 are illustrated as being currently up for auction. Other vehicles, labeled as vehicles #5 through #12, may be lined up to wait for the auction.

Each of the vehicles illustrated in FIG. 1A may include an in-vehicle device (illustrated as device “D”). The in-vehicle device may have been installed, for example, by the dealership or by another party (e.g., during manufacture). In one implementation, installation of the in-vehicle device may be performed by inserting the in-vehicle device into an OBD port of the vehicle. As mentioned, the in-vehicle device may include the ability to determine the location of the in-vehicle device (and hence the vehicle). For example, the in-vehicle device may determine location information based on Global Positioning System (GPS) data and/or some other technique (e.g., using short range wireless radio signals, RFID, QR code to determine location within the dealership or at another specified auction location).

A buyer that is interested in vehicles may desire to know, for example, the current location of the vehicles (e.g., to inspect the vehicles) and when the vehicles are scheduled to be auctioned. In some auction environments, the starting time of when a particular vehicle is to be auctioned may change based on auction progress of the vehicles ahead of the particular vehicle in the auction lane.

Consistent with aspects described herein, information, such as the current location of a vehicle and/or an updated auction time for a vehicle, may be provided to potential buyers based on the location information received from the in-vehicle device associated with the vehicle. For example, the dealership may provide a display (e.g., an electronic billboard) that graphically represents vehicles in the auction with respect to the current location of the vehicles, as well as an estimated auction time of the vehicles. The location of the vehicles on the display may be updated, based on the location information received from the in-vehicle device, as the vehicle moves through the dealership. The position of the vehicle in a particular auction lane may also be determined based on the location of the vehicle relative to other vehicles in the auction lane and/or relative to the head of the auction lane.

In some implementations, information based on the location of the vehicles may be provided to mobile devices (e.g., an application executing on a smart phone) of the buyers. In this implementation, the display provided to each buyer may be customized for the buyer. For example, the vehicles of interest to a particular buyer may be highlighted and/or other information may be provided relating to the vehicles of interest to the particular buyer.

FIG. 1B is a diagram illustrating one example of a visual diagram 110 that may be provided to potential buyers, such as an interface presented by an electronic billboard (e.g., a large screen TV or another electronic monitor) at a vehicle dealership, or a display presented by smart phones carried by potential buyers at the vehicle dealership. In FIG. 1B, information relating to eight vehicles, labeled as auto #1, auto #2, etc., is illustrated. For each vehicle, the information may include the current position in the auction lane of the vehicle, the estimated auction start time, and the current bid price or minimum bid price.

In FIG. 1B, the vehicle corresponding to auto #1 is indicated as being in “Lane 1, Position 1,” which may indicate that the vehicle is currently the first vehicle in the auction line corresponding to lane #1. For this vehicle, the estimated start auction time is given as “ongoing” and the current bid price is given as $3,500. Similarly, the vehicle corresponding to auto #2 is indicated as being in “Lane 2, Position 1,” the estimated auction start time is in “one minute” and the opening bid price is $50. For vehicles that are not in the first position in an auction lane, the estimated start auction time may be determined based on the current position of the vehicle in its respective auction lane. For example, the vehicle corresponding to auto #8 is indicated as being in “Lane 4, Position 2” and has as an estimated start auction time of 2:30 pm.

As previously mentioned, in some implementations, the in-vehicle device may obtain additional information relating to the operation of a particular vehicle, such as audio data obtained from a microphone and/or acceleration data obtained from an accelerometer. The audio data and/or acceleration data may be analyzed to provide additional information, such as diagnostic information, relating to the vehicle. The additional information may be provided to the potential buyer. For example, in the situation in which the potential buyer is using a smart phone to view auction-related information, such as information provided via visual display 110 (FIG. 1B), selection of the particular vehicle in visual display 110 may result in the additional information being presented to the user. For example, assume that a buyer selects a particular vehicle (“auto #1”) to view additional information about the vehicle.

As shown in FIG. 1C, the buyer may be provided with diagnostic information determined based on the OBD-II diagnostic protocol, audio data and acceleration data that was sensed by the in-vehicle device. In this particular example, the audio analysis indicates abnormal engines sounds (“audio analysis—slightly abnormal engine sounds”) and the acceleration analysis did not detect any issues (“accelerometer analysis—normal”).

An in-vehicle device, as will be described in more detail herein, may be used to enhance vehicle processing and sale at a vehicle dealership. The in-vehicle device may be used to enhance the auction process, enhance vehicle tracking within the dealership, and/or perform automated vehicle testing and reporting. In some implementations, a buyer may choose to keep the in-vehicle device after purchasing the vehicle. For example, the buyer may purchase a subscription for the in-vehicle device to provide post-purchase services to the buyer, such as automated accident monitoring and reporting services, emergency calling services, automated diagnostic reporting services, or other services.

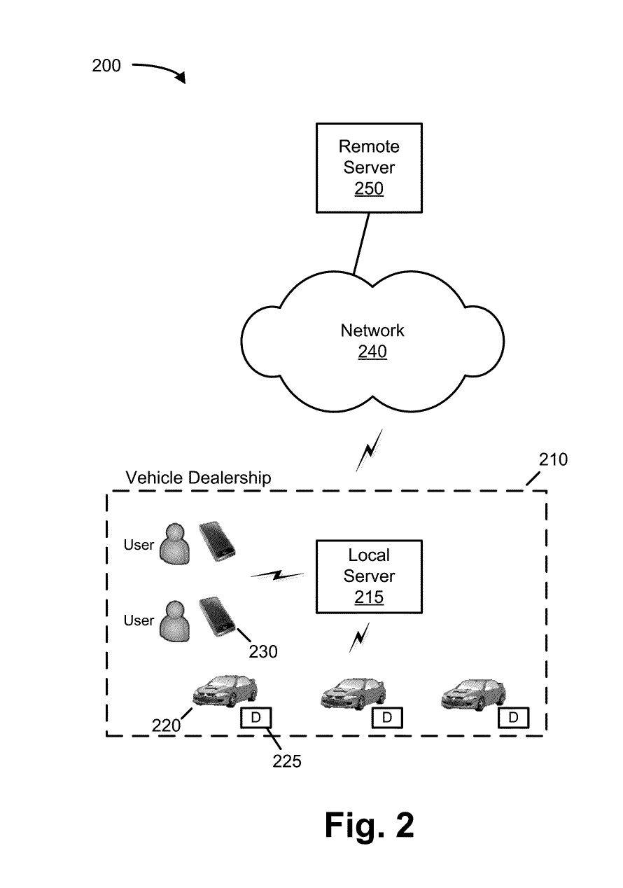

FIG. 2 is a diagram illustrating an example environment 200, in which systems and/or methods described herein may be implemented. Environment 200 particularly illustrates an example in which in-vehicle devices are used at a vehicle dealership, such as a dealership that performs vehicle auctions. As shown in FIG. 2, environment 200 may include vehicle dealership 210, network 240, and remote server 250. Vehicle dealership 210 may include local server 215 and vehicles 220. Vehicles 220 may be equipped with in-vehicle devices (“D”) 225. Customers interested in purchasing vehicles, referred to as users herein, may possess mobile devices 230 (e.g., smart phones).

Vehicle dealership 210 may represent an automobile dealership or physical retail location that sells automobiles. While referred to as a “dealership” herein, vehicle dealership 210 may be any type of entity that sells vehicles, such as a traditional vehicle dealership, a vehicle auction, a retail store, an owner of selling a vehicle, an representative selling a vehicle on behalf of a vehicle, etc. Vehicle dealership 210 may hold auctions for vehicles 220. Vehicles 220 may generally represent any vehicle that may be held, as inventory, by vehicle dealership 210. In some implementations, a vehicle 220 may include vehicles other than automobiles, such as boats, aircraft, etc. In-vehicle devices 225 may be installed by the vehicle dealership or by another entity (e.g., during manufacture of a vehicle 220). An example implementation of in-vehicle device 225 will be described in more detail below.

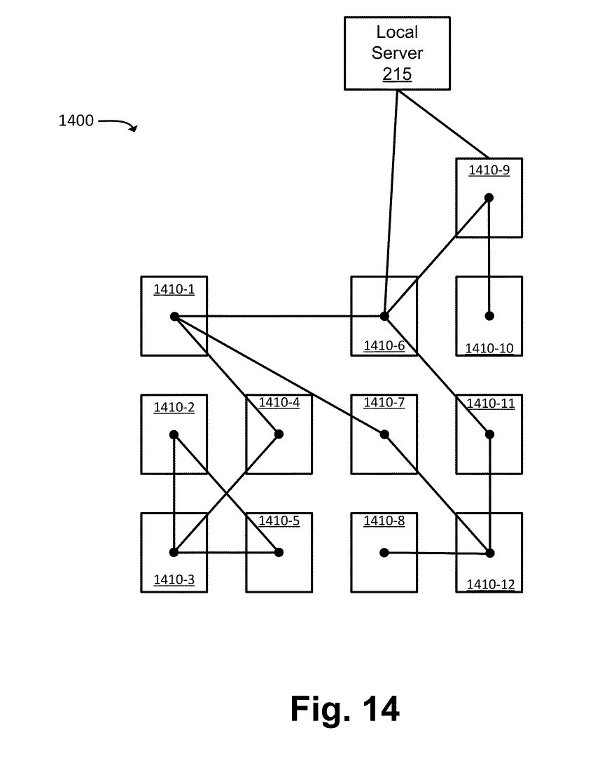

Local server 215 may include one or more computing devices that communicate with in-vehicle devices 225 and/or mobile devices 230. Local sever 215 may receive location information, such as geographical location information determined by GPS units included within in-vehicle devices 225. Alternative to location information from GPS, or in combination with information from a location determining system, other location determination technologies can be used (e.g., smartphone beacon technology to triangulate location from short range wireless transmitters, generation of mesh networks created by in-vehicle devices 225). In the mesh network scenario, in-vehicle devices 225 may ascertains a location of the in-vehicle device relative to other in-vehicle devices. Thus, each device may use information relating to other devices' locations by requesting and receiving node interrelationships. Alternatively, a cloud server, or local server, could build, maintain, and update a matrix corresponding to the mesh network, and make available the matrix data to the in-vehicle devices, or user devices such as smartphones, tablets, personal computers, remote browsers, etc. Implementations associated with a mesh network are described in more detail below with respect to FIG. 14.

The location information may be received, for example, directly from in-vehicle devices 225 (e.g., via a short range short range wireless connection) or indirectly from network 240 (e.g., in-vehicle devices 225 may first transmit the location information, via a cellular wireless communication link, to network 240). Local server 215 may use the location information to track the location of vehicles 220. For example, local server 215 may provide employees of vehicle dealership 210 with the location of a particular vehicle, such as in a particular parking spot or section of vehicle dealership 210. In some implementations, as described in more detail below, local server 215 may use the location information to facilitate vehicle auctions by providing users with real-time updates relating to the location of vehicles 220 and/or relating to the start time of particular auctions.

Mobile devices 230 may each include any computation and communication device, such as a wireless mobile communication device that is capable of communicating with network 240 and/or local server 215. For example, mobile device 230 may include a radiotelephone; a personal communications system (“PCS”) terminal (e.g., a device that combines a cellular radiotelephone with data processing and data communications capabilities); a personal digital assistant (“PDA”) (e.g., that can include a radiotelephone, a pager, Internet/intranet access, etc.); a smart phone; a laptop computer; a tablet computer; a camera; a personal gaming system; a smart watch (e.g., watches that can perform task and display information to a user by connecting to a local or remote server); a smart pair of glasses (e.g., glasses capable of connecting to local or remote servers containing a way to display information to a user), or another type of mobile computation and communication device.

Network 240 may represent a wireless network (e.g., a wireless cellular network) and/or a wired network through which mobile devices 230, in-vehicle devices 225, local server 215, and/or remote server 250 may communicate. Network 240 may include a wide area network (“WAN”), a metropolitan area network (“MAN”), the Internet, a fiber optic-based network, and/or a combination of these or other types of networks. In one implementation, network 240 may include a wireless network that is implemented based on the Long Term Evolution (“LTE”) standard. In other implementations, network 240 may include a wireless network implemented based on other standards, such as a Code Division Multiple Access (“CDMA”) 2000 1X network, a second generation (“2G”) wireless network, a third generation (“3G”) wireless network, a fifth generation (“5G”) wireless network, a “Wi-Fi” wireless network (e.g., a network that operates according to an Institute of Electrical and Electronics Engineers (“IEEE”) 802.11 standard), and/or another wireless network. In some implementations, network 240 may be communicatively coupled to one or more other networks.

Remote server 250 may include one or more computing devices that communicate with in-vehicle devices 225 and/or mobile devices 230. In one implementation, remote server 250 may be operated by an entity that provides services based on the installation of in-vehicle devices 225 in vehicles 220 (i.e., a telematics services provider). In-vehicle devices 225 may communicate, via a wireless connection with network 240, with remote server 250. Remote server 250 may receive and process information from in-vehicle devices 225, such as location information, audio data, acceleration data obtained by an accelerometer, or other information. In one implementation, remote server 250 may analyze the received information, such as the recorded audio data and/or acceleration data, to determine diagnostic information relating to the vehicle in which a particular in-vehicle devices 225 is installed. The analysis of the audio data and acceleration data to obtain the diagnostic information will be described in more detail below.

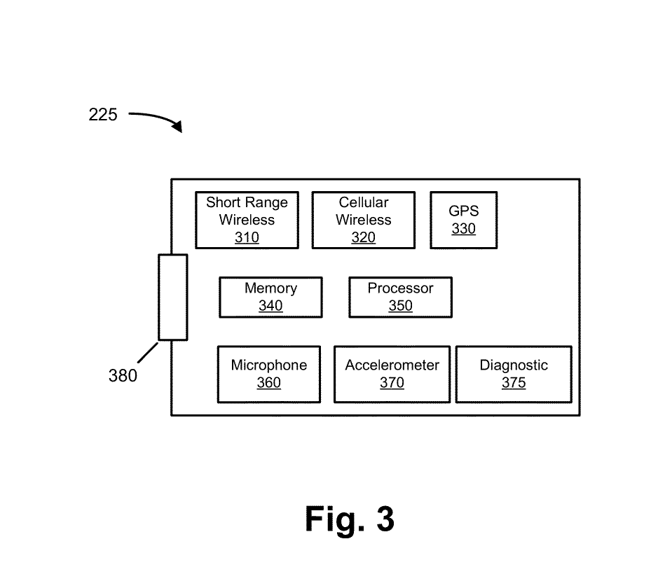

FIG. 3 is a block diagram conceptually illustrating an example of components that may be included within one of in-vehicle devices 225. The components shown in FIG. 3 may be included within a housing and may be implemented as a diagnostic or telematics dongle. In some implementations, in-vehicle device 225 may be configured to couple to an OBD-II port of a vehicle and may obtain electrical power from the port. In this situation, in addition to obtaining data from sensors implement within in-vehicle device 225, in-vehicle device 225 may obtain information from the OBD system of the vehicle. In other implementations, in-vehicle device 225 may be implemented independently of the OBD system of the vehicle.

As illustrated, in-vehicle device 225 may include short range wireless component 310, cellular wireless component 320, GPS component 330, memory 340, processor 350, microphone 360, accelerometer 370, diagnostic component 375, and connector 380 (e.g., OBD-II diagnostics connector).

Short range wireless component 310 may include an antenna, radio transceiver circuitry, and/or other circuitry to implement a short range wireless connection. A short range wireless connection may include a wireless connection formed over an unlicensed frequency band (i.e., a frequency band that may be legally used without requiring a license from an applicable government entity). Examples of possible short range wireless networking technologies, which may be implemented by short range wireless component 310, include WiFi (i.e., IEEE 802.11 based technologies), Bluetooth®, or other wireless technologies.

Cellular wireless component 320 may include an antenna, radio transceiver circuitry, and/or other circuitry to implement a radio interface with a wireless cellular network, such as network 240. A wireless cellular connection may include a wireless connection formed over a licensed frequency band (i.e., a frequency band that may be licensed by a telecommunications provider to provide cellular wireless service to customers). Cellular wireless connections may generally include longer connection ranges and wider connection areas than short range wireless connections.

GPS component 330 may include circuitry or other logic to receive and process GPS signals. GPS component 330 may obtain, or assist in obtaining, a geographic location of in-vehicle device 225. In other implementations, other satellite positioning systems, such as GLONASS, may alternatively or additionally be used.

Memory 340 may include any type of dynamic storage device that may store information and instructions for execution by processor 350, and/or any type of non-volatile storage device that may store information for use by processor 350. Processor 350 may include a processor, microprocessor, or processing logic that may interpret and execute instructions, such as instructions stored in memory 340. In-vehicle device 225 may perform certain operations that implement processes relating to obtaining and transmitting data (such as location data determined by GPS component 330, audio data sensed by microphone 360, and/or acceleration data sensed by accelerometer 370) to an external device, such as remote server 250. The processes will be described in more detail below. In-vehicle device 225 may perform these operations in response to processor 350 executing software instructions stored in a computer-readable medium, such as memory 340. A computer-readable medium may be defined as a non-transitory memory device.

Microphone 360 may include an electroacoustic transducer to sense sound. Accelerometer 370 may include a device to measure acceleration. Accelerometer 370 may measure proper acceleration and may output the measured acceleration as three values, corresponding to the measured acceleration values along orthogonal axes of the accelerometer. In some implementations, other sensors may be used to further improve the data obtained from accelerometer 370. For example, a gyroscope may be used to align in-vehicle device 225 with coordinate axes of the vehicle to facilitate processing of the acceleration data.

Diagnostic component 375 may include logic to implement diagnostic communications with vehicle 220. Diagnostic component 375 may communicate, through connector 380, with the OBD system of vehicle 220 to obtain diagnostic information relating to the operation of vehicle 220. Diagnostic component 375 may, for example, obtain diagnostic information relating to one or more systems or components in vehicle 220, such as breaking systems, emissions related systems, etc. Diagnostic component 375 may implement a number of protocols and/or standards in order to communicate with the OBD system of vehicle 220. For example, diagnostic component 375 may implement one or more of the following standards: Controller Area Network (CAN) bus standard, CAN2.0, SAE J1962, SAE J1850, ISO 9151-2, ISO 15230, and/or ISO 15765.

Connector 380 may be a physical connector designed to be plugged into an OBD port (using an OBD-II standardized interface) of a vehicle. When in-vehicle device 225 includes OBD connector 380, in-vehicle device 225 may be designed to obtain power from the OBD port of the vehicle. In other implementations, in which in-vehicle device 225 is not an OBD device, connector 380 may include a physical clip or other device designed to physically secure in-vehicle device 225 to vehicle 220. In vehicle models 1996 or newer, by government regulation, all cars sold in the United States use an SAE J1962 OBD-II connector. References herein to an OBD connector, OBD port, or OBD system may refer to an OBD-II based systems. Some jurisdictions may potentially use different OBD standards. In this case, the terms OBD connector, OBD port, or OBD system may more generally refer to any vehicle diagnostic system with a standardized interface.

Although not explicitly shown in FIG. 3, short range wireless component 310, cellular wireless component 320, GPS component 330, memory 340, processor 350, microphone 360, and accelerometer 370 may be connected to one another through one or more busses. Further, although FIGS. 2 and 3 illustrate example components of environment 200 and of in-vehicle device 225, in other implementations, environment 200 or in-vehicle device 225 may contain fewer components, different components, differently arranged components, or additional components than those depicted. Alternatively, or additionally, one or more components of environment 200 or in-vehicle device 225 may perform one or more other tasks described as being performed by one or more other components.

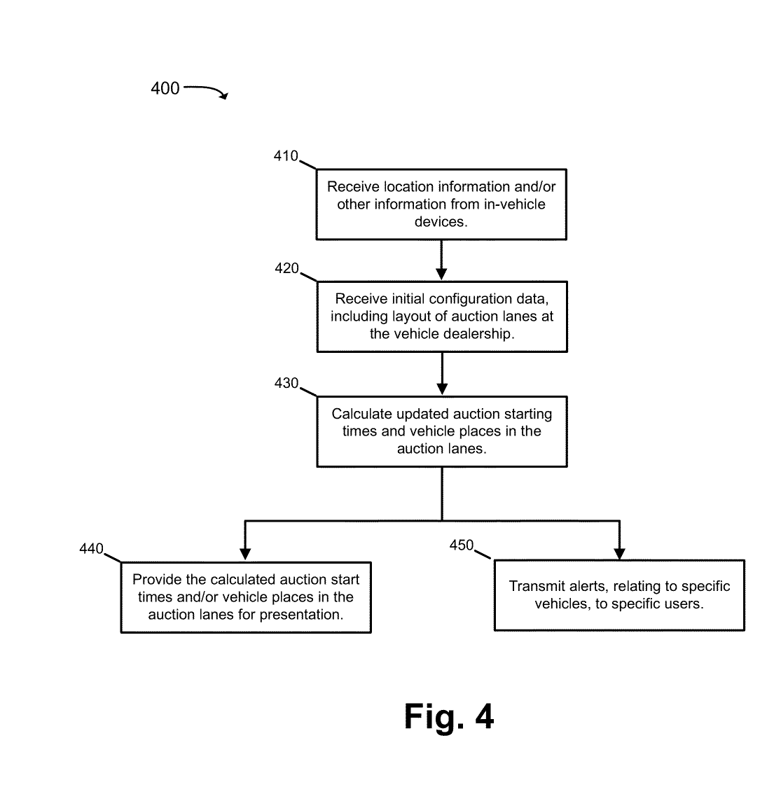

FIG. 4 is a flowchart illustrating an example process 400 relating to facilitating vehicle auctions at a dealership. Process 400 may be performed by, for example, local server 215 and/or remote server 250.

Process 400 may include receiving location information (and possibly other information, including diagnostic data or performance data) from the in-vehicle devices (block 410). For example, as mentioned, in-vehicle device 225 may be installed in vehicles 220 and may include position sensors, such as GPS component 330. In-vehicle devices 225 may transmit the location information, determined by the position sensors, to local server 215, such as by using short range wireless component 310 (e.g., a Bluetooth or WiFi connection). Alternatively, in-vehicle device 225 may transmit the location information to remote server 250, which may forward the location information to local server 215. The location information may be used to track the location of vehicles 220 that vehicle dealership 210.

In some implementations, in addition to the location information, in-vehicle device 225 may transmit other sensed data, such as audio or acceleration data, or information obtained from the OBD system of the vehicle. For example, in-vehicle device 225 may receive diagnostic information, from the OBD system of the vehicle, relating to the operational state of components of the vehicle. The diagnostic information may also be transmitted to local server 215 and/or remote server 250.

Process 400 may include receiving initial configuration data, including the layout of auction lanes at the vehicle dealership (block 420). The initial configuration data may thus effectively provide a map of vehicle dealership 210. In some implementations, the initial configuration data may include other information, such as scheduled start times of vehicle auctions. The initial configuration data may be input, for example, by an administrator or other user associated with vehicle dealership 210.

Process 400 may further include calculating updated auction starting times and vehicle places in the auction lanes (block 430). The updated start times and/or vehicle places in the auction lanes may be based on the received location information. For example, based on the received location information in the configuration data, local server 215 may determine the particular vehicles in each of the auction lanes, may determine the order of the vehicles in each of the auction lanes, and may estimate a rate at which vehicles in each of the auction lanes move forward in the auction lane (e.g., the average length of the vehicle auctions may be determined). The updated auction start time, for a particular vehicle, may be estimated based on the current position of the particular vehicle in the auction lane and based on the estimated rate at which vehicles in the auction lane move forward. For example, if a particular vehicle is third in line for an auction and the auctions for the lane tend to start five minutes apart, the updated auction start time may be estimated as ten minutes from the current time.

The calculated auction start times and vehicle places in the auction lanes may be used in a number of ways, two of which are illustrated in blocks 440 and 450.

Process 400 may further include, in block 440, providing the calculated auction start times and/or the vehicles places in the auction lanes for presentation. As mentioned previously, the auction start times and/or vehicle places may be provided through relatively large electronic billboard (or other display) installed at vehicle dealership 210. For instance, a table may be presented that indicates: the make/model of vehicles that are up for auction, the auction lane assigned to each of the vehicles, the current place in line for each of vehicles, and the estimated start time of the auction for each of the vehicles. The table may be updated as location information is received for vehicles 220. Alternatively or additionally to displaying the table through a public display (i.e., the electronic billboard or other display), in some implementations, users may use mobile devices 230 to view the calculated auction start times and/or vehicle places in the auction lanes. For example, mobile devices 230 may communicate with local server 215 and/or remote server 250 to obtain the information.

Process 400 may further include transmitting alerts, relating to specific vehicles, to users (block 450). For example, a user of mobile device 230 may, through an application installed on mobile device 230, register to be alerted about changes in the status of one or more vehicles 220 in which the user is interested. Local server 215 (or remote server 250) may transmit an alert to mobile device 230 whenever conditions of the alert are satisfied (e.g., whenever one of the vehicles in which the user is interested is about to be auctioned, when one of the vehicles is a certain time period away from beginning an auction, whenever the highest bid amount for a particular vehicle changes, etc.). Mobile device 230 may provide the alert, such as through a visual or audible alert, to the user.

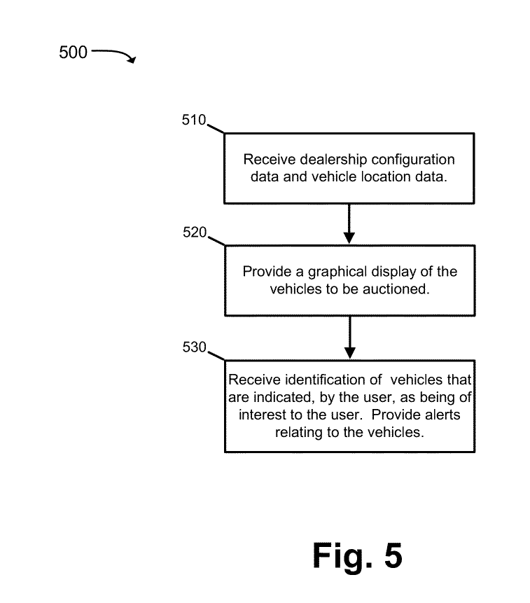

FIG. 5 is a flowchart illustrating an example process 500 relating to facilitating vehicle auctions at a dealership. Process 500 may be performed by, for example, mobile device 230, such as via an application executing at a mobile device that is being used by a buyer at a vehicle auction.

Process 500 may include receiving dealership configuration data and vehicle location data (block 510). The dealership configuration data and vehicle location data may be received, for example, from local server 215 and or/remote server 250. The dealership configuration data may include information relating to the particular vehicle dealership in which the user is shopping, such as a list of vehicles that are for sale at the dealership and/or information providing a map or graphical layout of the dealership.

Process 500 may further include providing a graphical display of the vehicles that are to be auctioned by the dealership (block 520). The graphical display may include information organized as a graphical view of vehicles in auction lanes (e.g., similar to FIG. 1A) and/or as a table of information (e.g., similar to FIG. 1B). The graphical display may provide information such as, for example, general information about different vehicles, diagnostic or maintenance information about vehicles in which the user is interested, the location of a vehicle in the dealership, the place in the auction lane of the vehicle, information relating to the start time of an auction of the vehicle, or other information. The graphical display may be formatted for displaying on a mobile user device. Or, the graphical display may be formatted for display on a larger display, such as a computer monitor, or for display on a large screen which may be used at an auction so that attendees at the auction can view it.

Process 500 may further include receiving, from the user, indications of vehicles that are of interest to the user (block 530). For example, the user may select, via the graphical display, vehicles that the user is particularly interested in monitoring during the auction. As mentioned, alerts may be provided to the user relating to vehicles in which the user is interested (block 530).

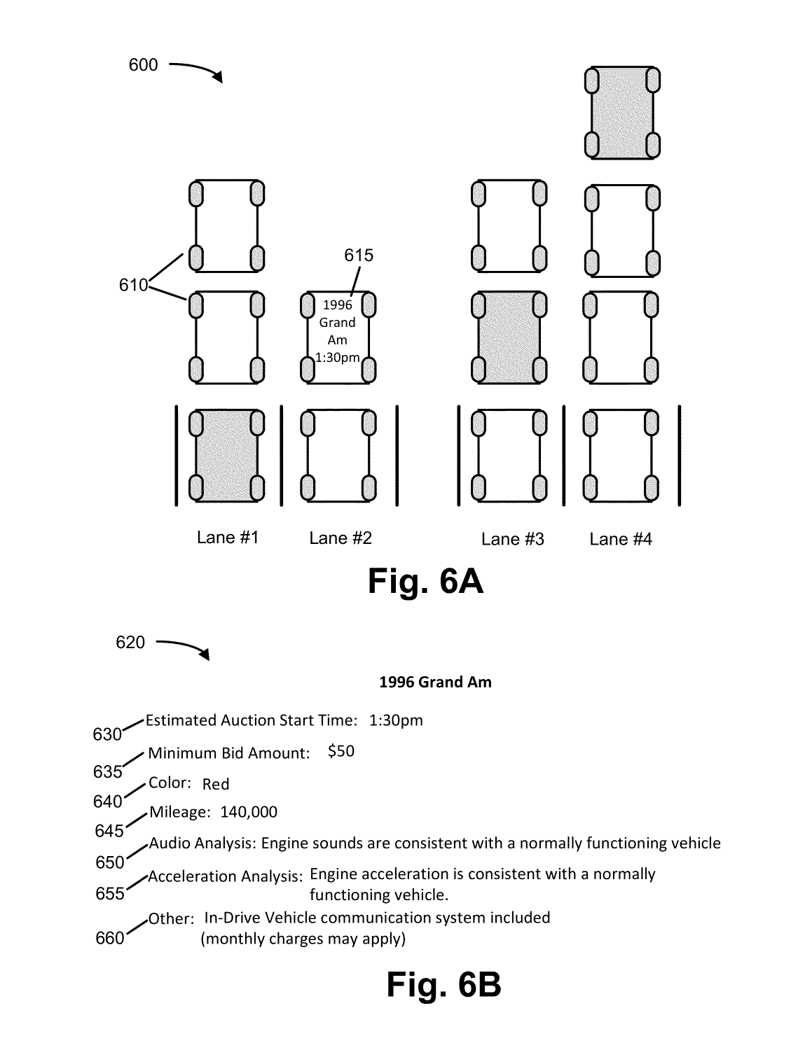

FIGS. 6A and 6B are diagrams illustrating an example of a graphical interfaces 600 (FIG. 6A) and 620 (FIG. 6B), such as an interface provided by mobile device 230. Graphical interface 600 may be provided consistent with the providing of a graphical display of the vehicles that are to be auctioned, as performed in block 520 (FIG. 5).

As illustrated in FIG. 6A, graphical interface 600 may include graphic representations 610 and 615 of a number of vehicles. Graphical representations 610 and 615 may each be illustrated in a manner that provides information relating to the auction lane to which the vehicle is assigned and the relative position of the vehicle in the auction lane. In the illustrated example, graphical representation 615 includes an estimated start time of the corresponding auction and an indication of the model of the vehicle (e.g., “1996 Grand Am, 1:30 pm”). In some implementations, a user may be able to graphically select (such as through a touch gesture) the graphical representation of the vehicle to obtain additional information about the vehicle and/or to indicate that the user would like to receive alerts relating to the selected vehicle. Graphical interface 600 may visually differentiate vehicles corresponding to vehicles that are selected to receive alerts, such as by showing a different graphical representation of a vehicle or by modifying the coloring of the selected vehicles. In FIG. 6A, the vehicles for which a user has selected to receive alerts are illustrated via shading.

FIG. 6B illustrates an example of a graphical interface that may be used to provide additional information relating to a particular vehicle selected by the user. For example, assume that a user selects (e.g., via a touch gesture) graphical representation 615 of a vehicle. In response, mobile device 230 may provide graphical interface 620, which may present additional information relating to this vehicle. As shown in FIG. 6B, graphical interface 620 may provide a number of items of information about a particular vehicle, such as: estimated auction start time 630 (“1:30 pm”), minimum bid amount for the auction 645 (“$50”), color 640 of the vehicle (“Red”), mileage of the vehicle 645 (“140,000”), audio analysis 650 relating to the vehicle (“Engine sounds are consistent with a normally functioning vehicle”), acceleration analysis 655 relating to the vehicle (“Engine acceleration is consistent with a normally functioning vehicle”), and other information 660 (“In-Drive Vehicle communication system included (monthly charges may apply)”).

Audio analysis 650 and acceleration analysis 655 may be generated based on data received from microphone 360 and accelerometer 370, respectively, of in-vehicle device 225. The performance of the audio analysis and the acceleration analysis, based on data from in-vehicle device 225, will next be described in more detail.

In one implementation, audio data used to perform the audio analysis may be obtained from vehicles during normal operation of the vehicles. For example, in-vehicle device 225, of a particular vehicle, may occasionally record, using microphone 360, a sample of audio data (e.g., a five second sample). In-vehicle device 225 may upload the audio data to remote server 250 which may aggregate audio data from a number of vehicles. Server 250 may analyze the audio data to determine “normal” engine sounds for vehicles (e.g., vehicles of the same make, model, similar engines, etc.). Alternatively, the analysis of the audio data may be performed “locally,” such as by in-vehicle device 225 or by mobile device 230 of the user.

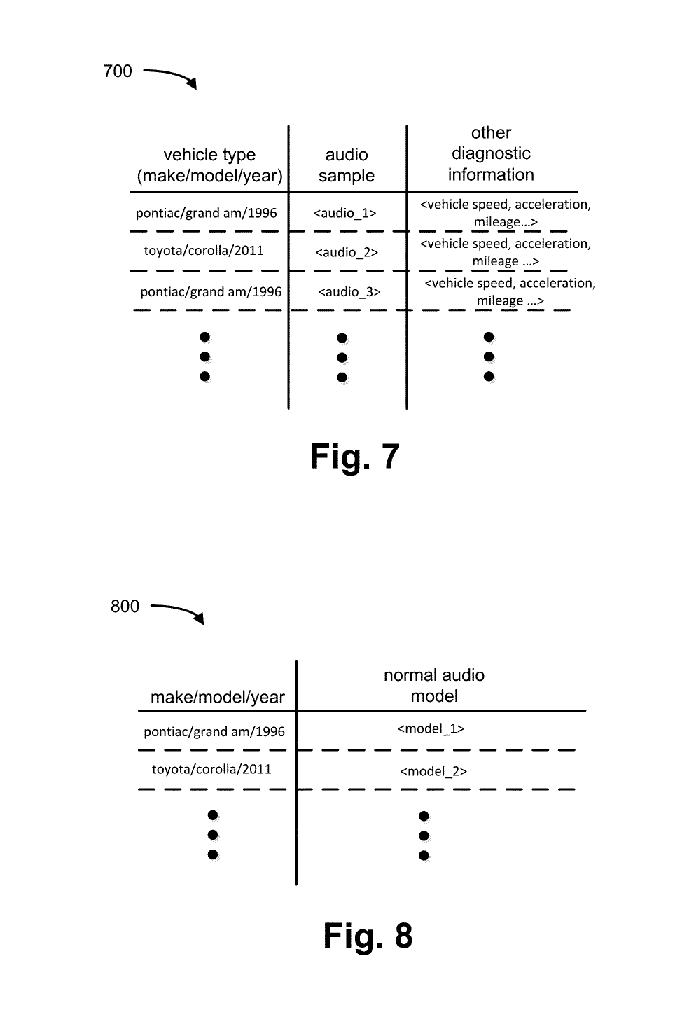

FIGS. 7 and 8 are diagrams illustrating example data structures 700 and 800, respectively, such as a data structure that may be maintained by remote server 250. As illustrated, each entry for data structure 700 may relate to a particular vehicle type (e.g., a make/model/year of a vehicle), and may include an audio sample from a vehicle of the particular vehicle type and other diagnostic information relating to the vehicle at the time of the audio sample.

For example, as illustrated in data structure 700, two samples are illustrated for the vehicle type “pontiac/grand am/1996.” The samples may be from different vehicles or from the same vehicle at different times. In general, for any particular vehicle type, it may be desirable to obtain a large number of samples (e.g., on the order of 100 or more) from a number of separate vehicles. Each audio sample may be of a certain predetermined length and/or different audio samples may be of different lengths.

In some implementations, in-vehicle device 225, when recording an audio sample, may record additional information relating to the operational state of the vehicle during the audio sample. The additional information may be information directly recorded by in-vehicle device 225 or obtained from the OBD system of the vehicle. The additional information is illustrated in data structure 700 as “other diagnostic information.” A non-limiting example of the types of additional information may include: speed of the vehicle, or engine, during the audio sample, acceleration of vehicle during the audio sample, coolant temperature information, battery voltage information, mass airflow information, information relating to the state of engine components or other parameters that can be monitored via the OBD system, or other information.

Remote server 250 may analyze data structure 700 to obtain, for a particular vehicle type, a model that generally defines normal or expected engine sounds for the particular vehicle type. The model may include, for example, one or more parameters, equations, expressions, or sets of values that can be applied to an audio sample from another vehicle of the particular vehicle type to determine whether engine sounds (or other sounds) of the another vehicle are consistent with a normally functioning vehicle. When generating a model for a particular vehicle type, remote server 230 may analyze a number of audio samples (e.g., from data structure 700). The analysis may include, for example, preprocessing of the audio samples to remove external sounds (e.g., user speech), converting the audio samples into the frequency domain, and analyzing the frequency domain spectral signals to generally determine common elements or characteristics of the frequency domain signals. In some implementations, analyzing the frequency domain may be based on the spectral density of the frequency domain signals and may include determining outliers, based on the spectral density, which may indicate abnormal audio. In some implementations, the other diagnostic information may be used to further refine the analysis. For example, the audio sounds associated with an accelerating vehicle of a particular vehicle type may be analyzed. As another example, remote server 250 may use the other diagnostic information to determine when a particular vehicle is experiencing abnormal and/or non-optimal operating conditions. The frequency domain signals may then be analyzed to correlate particular abnormal and/or non-optimal operating conditions to particular characteristics in the frequency domain. For example, a fast Fourier transform may be used to obtain the frequency domain signals and a multi-variant regression technique may then be used to classify frequency characteristics, of the frequency domain signal. The classified frequency characteristics may indicate whether when a particular vehicle is experiencing abnormal and/or non-optimal operating conditions.

Based on results of the analysis, data structure 800 may be determined, which may relate the vehicle types (e.g., particular vehicle make/model/years) to audio models that define normal sounds for the particular vehicle type. In some implementations, an audio metric (e.g., a score from zero to ten) may be generated which may indicate a quality of engine sounds of the vehicle. As illustrated in data structure 800, the vehicle type “pontiac/grand am/1996” may be associated with the normal audio model labeled as “model_1” and the vehicle type “toyota/corolla/2011” may be associated with the normal audio model labeled as “model_2.” In some implementations, the normal audio model may alternatively or additionally include information relating to audio that characterizes abnormal and/or non-optimal operating conditions.

The fields shown above for data structure 700 and 800 are examples. In alternative possible implementations, different, fewer, or additional fields may be implemented.

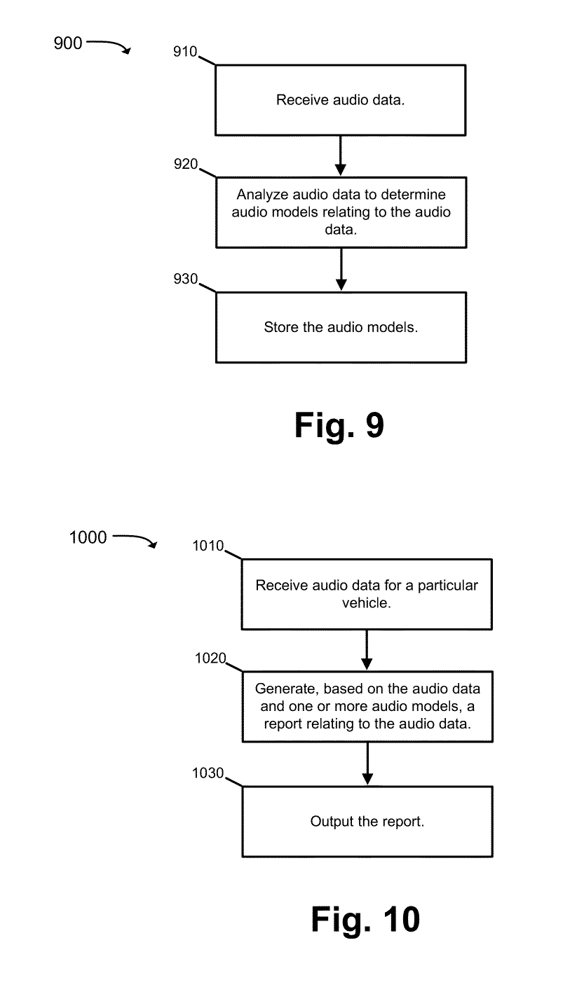

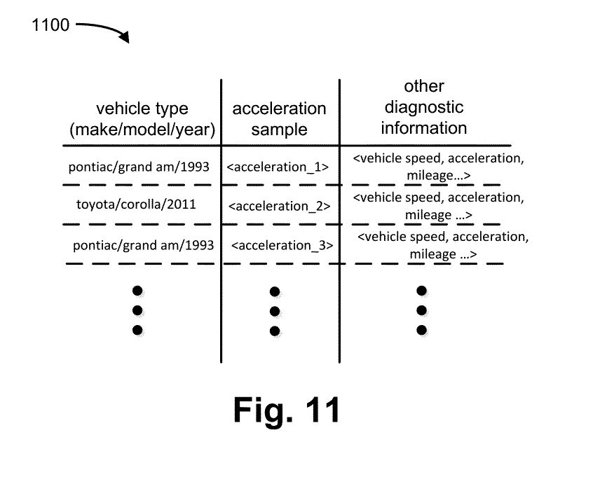

FIGS. 9 and 10 are flowcharts illustrating example processes, processes 900 and 1000, respectively, relating to analysis of vehicle acceleration data. Processes 900 and 1000 may be performed by, for example, local server 215 and/or remote server 250.

Process 900 may generally relate to receiving samples of audio data from a number of vehicles and processing the audio data to determine audio models. As previously mentioned, the samples of audio data may be received from in-vehicle device 225 of a number of vehicles.

Process 900 may include receiving audio data (block 910). As mentioned, in-vehicle device 225 may record audio data, either periodically or occasionally, and may transmit, such as via network 240, the audio data to remote server 250. In addition to the audio data, in some implementations, other diagnostic information may be transmitted with the audio data (e.g., speed of the vehicle during the recording of the audio data, acceleration of the vehicle during the recording of the audio data, etc.). The audio data may be stored, such as is illustrated in data structure 700.

Process 900 may include analyzing the audio data to determine models relating to the audio data (block 920). As previously mentioned, the analysis may include analyzing a number of audio samples from a particular vehicle type to determine a model(s) that can be used to determine whether engine sounds of the particular vehicle type are normal, abnormal, and/or non-optimal. In some implementations, the analysis may be performed in the frequency domain.

Process 900 may further include storing the audio models (block 930). As illustrated in data structure 800, a different audio model may be generated and stored for each type of vehicle. Stored audio models may be used to generate output reports (e.g., “engine sounds are consistent with a normally functioning vehicle”) associated with an audio sample received from a particular vehicle.

The audio models generated with respect to process 900 may be used to provide reports relating to an audio analysis of vehicles equipped with in-vehicle device 225. In one implementation, and as described previously, a report relating to the audio analysis may be provided as information provided to a buyer at a vehicle auction. In other implementations, the report relating to the audio analysis may be provided at other times. For example, in-vehicle device 225 may operate during the normal course of operation of a vehicle. In-vehicle device 225 may occasionally transmit diagnostic information, including recorded audio data, to remote server 250. Remote server 250 may apply the relevant audio models and, when an abnormal condition is detected, alert the user associated with vehicle 220.

Process 1000 may generally include operations relating to generation and output of a report relating to audio data recorded by in-vehicle device 225. Process 1000 may include receiving audio data for a particular vehicle (block 1010). As previously mentioned, in some implementations, other diagnostic information may also be associated with received audio data.

Based on the audio data and one or more audio models (as generated with respect to process 900), process 1000 may additionally include generating a report relating to the audio data. The report may be based on an output of the one more audio models and may generally relate to a comparison of the sound of the engine associated with vehicle 220 to the sound of normally functioning engines in other vehicles of the same type. The report may particularly highlight any abnormal or not optimal operating conditions that were detected from the audio data. The report may be output (block 1030), such as by transmitting or otherwise providing the report to the user associated with vehicle 220.

As previously mentioned, acceleration data, in addition to or alternatively to audio data, may also be obtained from in-vehicle device 225. The acceleration data may be used to generate reports based on an analysis of the acceleration data. As with the audio data, in one implementation, the acceleration data used to perform the acceleration analysis may be obtained from vehicles during normal operation of the vehicles. For example, in-vehicle device 225, of a particular vehicle, may occasionally record, using accelerometer 370, a sample of acceleration data (e.g., a five second sample). In-vehicle device 225 may upload the acceleration data to remote server 250 which may aggregate acceleration data from a number of vehicles. Server 250 may analyze the acceleration data to determine “normal” engine acceleration patterns and/or to determine whether a vehicles suspension system or ride quality is abnormal.

FIG. 11 is a diagram illustrating an example data structure 1100, such as a data structure that may be maintained by remote server 250. As illustrated, each entry for data structure 1100 may relate to a particular vehicle type (e.g., a make/model/year of a vehicle), and may include an acceleration sample from a vehicle of the particular vehicle type and other diagnostic information relating to the vehicle at the time of the sample. Data structure 1100 may generally be similar to data structure 700 (FIG. 7), but may be used to store acceleration data instead of audio data.

For example, as illustrated in data structure 1100, two samples are illustrated for the vehicle type “pontiac/grand am/1996.” The samples may be from different vehicles or from the same vehicle at different times. In some implementations, in-vehicle device 225, when recording an acceleration sample, may record additional information relating to the operational state of the vehicle during the acceleration sample. The additional information may be information directly recorded by, or calculated by, in-vehicle device 225 or obtained from the OBD system of the vehicle. The additional information is illustrated in data structure 1100 as “other diagnostic information.” A non-limiting example of the types of additional information may include: speed of the vehicle during the acceleration sample, mileage of the vehicle, information relating to the state of engine components that can be monitored via the OBD system, or other information.

In one implementation, different vehicles may be driven over a standardized or known test track, such as a test section of roadway that includes a number of obstacles such as bumps, to obtain acceleration samples corresponding to the known obstacles on the test track. The amount of acceleration experienced by different vehicles, for the different obstacles, may relate to quality of the suspension system and/or to general ride quality of the vehicle.

In one implementation, remote server 250 may analyze data structure 1100 to obtain, for a particular vehicle type, a model that generally defines normal or expected engine sounds for the particular vehicle type. The model may include, for example, one or more parameters, equations, expressions, or sets of values that can be applied to an acceleration sample from another vehicle of the particular vehicle type to determine whether acceleration of the vehicle is consistent with a normally functioning vehicle. For example, a “normally functioning vehicle” may be one in which the vehicle is capable of accelerating at a normal rate, whether the suspension of the vehicle dampens bumps or other vehicle vibration in a normal manner, or other acceleration-based diagnostic metrics. As an example, a “suspension metric,” such as a value between zero and ten, may be generated that indicates a quality of the suspension system of a vehicle.

The fields shown above for data structure 1100 are examples. In alternative possible implementations, different, fewer, or additional fields may be implemented.

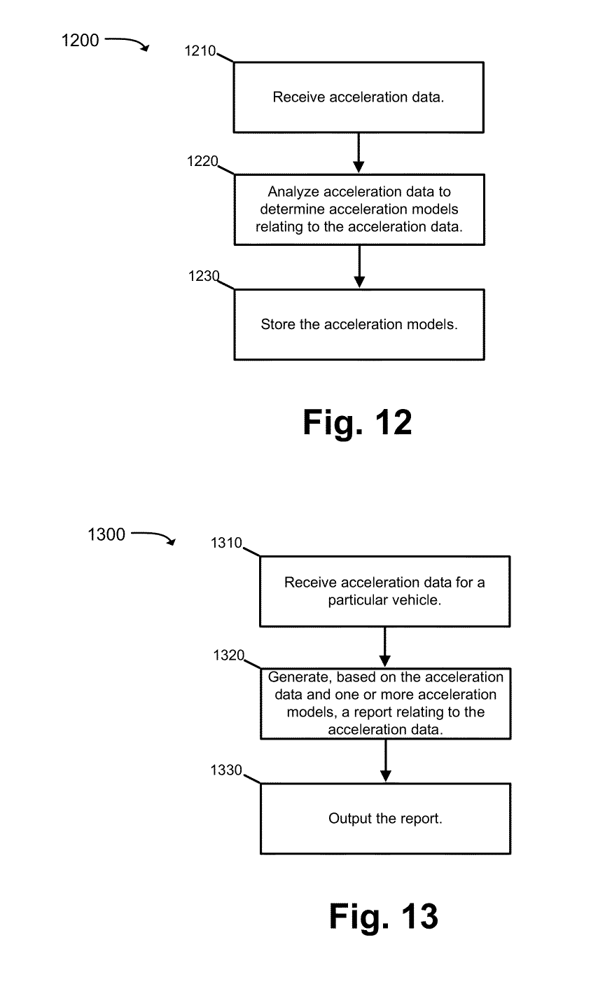

FIGS. 12 and 13 are flowcharts illustrating example processes, processes 1200 and 1300, respectively, relating to analysis of vehicle acceleration data. Processes 1200 and 1300 may be performed by, for example, local server 215 and/or remote server 250.

Process 1200 may generally relate to receiving samples of acceleration data from a number of vehicles and processing the acceleration data to determine audio models. As previously mentioned, the samples of acceleration data may be received from in-vehicle device 225 of a number of vehicles.

Process 1200 may include receiving acceleration data (block 1210). In-vehicle device 225 may record acceleration data, either periodically or occasionally, and may transmit, such as via network 240, the acceleration data to remote server 250. In addition to the acceleration data, in some implementations, other diagnostic information may be transmitted with the acceleration data (e.g., speed of the vehicle during the recording of the audio data). The acceleration data may be stored, such as is illustrated in data structure 700.

Process 1200 may include analyzing the acceleration data to determine models relating to the acceleration data (block 1220). As previously mentioned, the analysis may include analyzing a number of acceleration samples from a particular vehicle type to determine a model or models that can be used to determine normal acceleration for a particular vehicle type.

Process 1200 may further include storing the acceleration models (block 1230). In some implementations, a different acceleration model may be generated and stored for each type of vehicle. Stored acceleration models may be used to generate output results (e.g., “engine acceleration is consistent with a normally functioning vehicle”) associated with an acceleration sample received from a particular vehicle.

The acceleration models generated with respect to process 1200 may be used to provide reports relating to an acceleration analysis of vehicles equipped with in-vehicle device 225. In one implementation, and as described previously, the report relating to the acceleration analysis may be provided as information provided to a buyer at a vehicle auction. In other implementations, a report relating to the acceleration analysis may be provided at other times. For example, in-vehicle device 225 may operate during the normal course of operation of a vehicle. In-vehicle device 225 may occasionally transmit diagnostic information, including recorded acceleration data, to remote server 250. Remote server 250 may apply the relevant acceleration models and, when an abnormal condition is detected, alert the user associated with vehicle 220.

Process 1300 may generally include operations relating to generation and output of a report relating to acceleration data recorded by in-vehicle device 225. Process 1300 may include receiving acceleration data for a particular vehicle (block 1310). As previously mentioned, in some implementations, other diagnostic information may also be associated with received acceleration data.

Based on the acceleration data and one or more acceleration models (e.g., as generated with respect to process 1200), process 1300 may additionally include generating a report relating to the acceleration data (block 1320). The report may be based on an output of the one or more acceleration models and may generally relate to whether acceleration experienced by the vehicle, such as acceleration events experienced in response to hitting bumps or the driver accelerating the vehicle, indicate abnormal operation of the vehicle. The report may particularly highlight any abnormal or non-optimal operating conditions or system states (e.g., poor motor acceleration or poor vehicle suspension) that were detected from the acceleration data. The report may be output (block 1330), such as by transmitting or otherwise providing the report to the user associated with vehicle 220.

In the above description, the location of in-vehicle devices 225, and hence the location of vehicles 220 at vehicle dealership 210, was generally described as being determined based on the in-vehicle device directly determining its location (such as via GPS component 330) and transmitting the location to local server 215 and/or remote server 250. Alternatively or additionally, as described below with respect to FIG. 14, a number of in-vehicle devices 225 may form a mesh network, such as an ad-hoc mesh network. The mesh network may relay information to local server 215 and/or remote server 250. The mesh network may provide location information for vehicles 220 that may be used in place of or to supplement the GPS-based location information. Additionally, in some implementations, the mesh network may relay information from in-vehicle devices 225, via short range wireless connections between in-vehicle devices 225. In this manner, in-vehicle devices 225 that are out of range of local server 215 (i.e., out of range of a direct short range wireless connection with local server 215), may still communicate with local server 215 using the mesh network to relay communications between the in-vehicle devices and local server 215.

FIG. 14 is a diagram illustrating an example of a mesh network 1400 that may be created by in-vehicle devices 225 that are installed in vehicles 220. A mesh network may refer to a network topology in which nodes in the network relay data for the network. All nodes may cooperate in the distribution of data in the network. An ad hoc mesh network may refer to a self-configuring mesh networking in which nodes of the network may dynamically discover one another and be added to the network.

In FIG. 14, assume that mesh network 1400 is formed by nodes 1410-1 through 1410-12, that may each correspond to an in-vehicle device 225 that is installed in a vehicle 220 at vehicle dealership 210. Nodes 1410 may correspond to vehicles 220 that are in auction lanes in the configuration shown in FIG. 6A. Nodes 1410 may communicate with one another to form mesh network 1400 using short range wireless communications, such as via Bluetooth, WiFi Direct, or other short range wireless connection standards. Local server 215 may also act as a node in mesh network 1400.

Connectivity between nodes in mesh network 1400 is illustrated in FIG. 14 via lines. For example, node 1410-1 may directly communicate with nodes 1410-4, 1410-6, and 1410-7. Local server 215 may connect to network 1400 via nodes 1410-6 and 1410-9.

In one implementation, nodes 1410, in mesh network 1400, may dynamically be added and removed from mesh network 1400 as nodes 1410 come into range of mesh network 1400. For example, as a new vehicle enters an auction lane, in-drive device 225 of the new vehicle may discover a node 1410 and add itself to mesh network 1400.

In some implementations, nodes 1410 may be able to determine the relative physical position of itself with respect to other nodes in the network. For example, by using multilateration techniques based on packet latency information, range measurements taken using received signal strength indicator (RSSI), range measurements taken using received signal strength indicator (RSSI), and/or measurement of the angle of arrival of signals using multiple antennas, the relative physical position of nodes, in mesh network 1400, may be determined.

The determined relative physical positions of nodes 1410 may be mapped to auction lane configurations. For example, assume local server 215, via mesh network 1400, is provided with relative physical location information of nodes 1410. Local server 215 may know its physical position and may know the location and identity of the nodes at the front of the auction lane (e.g., nodes 1410-3, 1410-5, 1410-8, and 1410-12). Given this information, local server 215 may determine which vehicles are in which auction lanes and the order of the lines that correspond to the auction lanes. Alternatively or additionally, in some implementations, the auction lanes may be dynamically determined. For example, based on the fact that vehicles in an auction lane may tend to sequentially move forward, in single file, within the auction lane, local server 215 may dynamically determine the number and/or location of the auction lanes, potentially without a user needing to input configuration information describing the layout of the auction lanes.

In some implementations, local server 215 (or another device) may maintain a matrix (a “mesh matrix”) that describes a current topology of mesh network 1400. As vehicles are auctioned, the mesh matrix may update by querying one or more of in-vehicle devices 225, which then may reply with the relative positions of other in-vehicle devices 225. Thus, the device or process that builds, maintains, and/or updates the mesh matrix may not need poll all in-vehicle devices to have an updated matrix. As nodes disappear, or leave the matrix (i.e., a vehicle corresponding to a particular in-vehicle device, or node is auctioned), the device or process that updates the matrix can provide updated information of when other nodes, or vehicles corresponding to a given in-vehicle device, will likely be up for auction. As nodes leave the mesh matrix and remaining nodes change positions in the mesh matrix, the updating of the mesh matrix can be used to provide an updated prediction of time-to-auction for each remaining node. The updated prediction may be based on an analysis of the position of the node in an auction lane and an estimated throughput for an auction lane. The analysis to predict time-to-auction may include overlaying the location information from the mesh network with an auction facility floor plan, which typically includes multi-lane auctions, but could also include a single lane auction facility. By analyzing the mesh network with respect to the auction facility floor plan, an application or process can provide a real-time prediction of the flow of vehicles through a given lane and thus predict when a given node, or vehicle corresponding to the node in the given lane, will be up for auction. The inputs to the process that uses the updated mesh matrix may include: time a node changes positions in a lane relative to the auction podium corresponding to its lane, the number of nodes in queue that haven't reached their respective auction podium, and time for a given node to increment from one position in a lane to a next position that is closer to the auction podium. (i.e., the vehicle moves one position closer to the podium). These inputs/parameters could be input into a supervised machine-learning algorithm process, i.e., a process running a neural network, binary regression tree, or multi-variant regression algorithm, etc. The machine-learning algorithm/process could use the inputs and location information from the mesh matrix and process the information to train itself for use in predicting the time-to-auction of a given node/vehicle (i.e., to predict when a given vehicle will reach its corresponding auction podium).

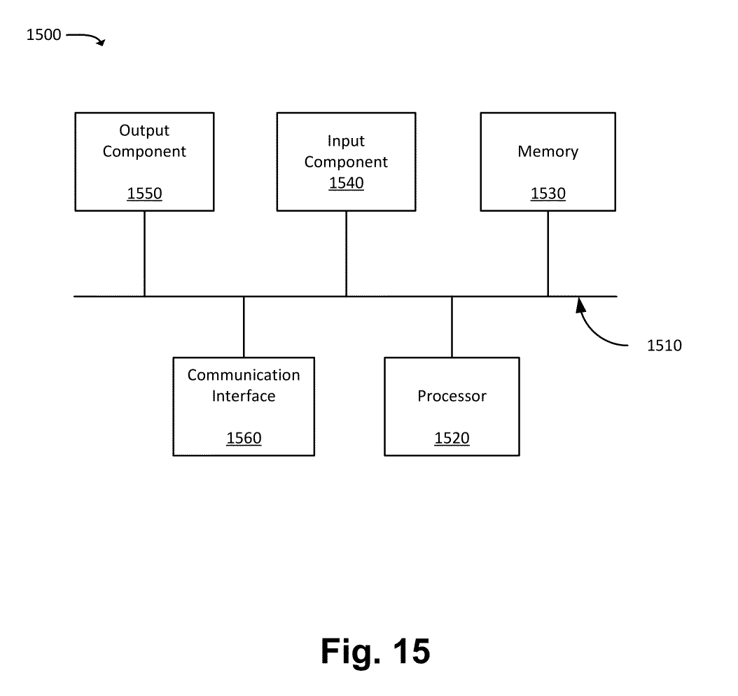

FIG. 15 is a diagram of example components of a device 1500. One or more of the devices described above (e.g., as described with respect to FIGS. 1-3) may include one or more devices 1500. Device 1500 may include bus 1510, processor 1520, memory 1530, input component 1540, output component 1550, and communication interface 1560. In another implementation, device 1500 may include additional, fewer, different, or differently arranged components.

Bus 1510 may include one or more communication paths that permit communication among the components of device 1500. Processor 1520 may include a processor, microprocessor, or processing logic that may include processing circuitry to interpret and execute instructions. Memory 1530 may include any type of dynamic storage device that may store information and instructions for execution by processor 1520, and/or any type of non-volatile storage device that may store information for use by processor 1520.

Input component 1540 may include a mechanism that permits an operator to input information to device 1500, such as a keyboard, a keypad, a button, a switch, etc. Output component 1550 may include a mechanism that outputs information to the operator, such as a display, a speaker, one or more light emitting diodes (“LEDs”), etc.

Communication interface 1560 may include any transceiver-like mechanism that enables device 1500 to communicate with other devices and/or systems. For example, communication interface 1560 may include an Ethernet interface, an optical interface, a coaxial interface, or the like. Communication interface 1560 may include a wireless communication device, such as an infrared (“IR”) receiver, a Bluetooth® radio, a Wi-Fi radio, a cellular radio, or the like. The wireless communication device may be coupled to an external device, such as a remote control, a wireless keyboard, a mobile telephone, etc. In some embodiments, device 1500 may include more than one communication interface 1560. For instance, device 1500 may include an optical interface and an Ethernet interface.

Device 1500 may perform certain operations relating to one or more processes described above. Device 1500 may perform these operations in response to processor 1520 executing software instructions stored in a computer-readable medium, such as memory 1530. A computer-readable medium may be defined as a non-transitory memory device. A memory device may include space within a single physical memory device or spread across multiple physical memory devices. The software instructions may be read into memory 1530 from another computer-readable medium or from another device. The software instructions stored in memory 1520 may cause processor 1520 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 4, 5, 9, 10, 12, and 13, the order of the blocks may be modified in other implementations. Further, non-dependent blocks may be performed in parallel. In some implementations, additional blocks may be performed before, after, or in between the described blocks.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method, implemented by one or more computing devices, comprising:
receiving, by the one or more computing devices, location information from a plurality of vehicles;
determining, by the one or more computing devices and based on the location information, places of the plurality of vehicles in a plurality of auction lanes;
calculating, by the one or more computing devices and based on the determined places of the plurality of vehicles, updates to auction start times associated with at least one of the plurality of vehicles in the plurality of auction lanes; and
outputting, by the one or more computing devices, the updated auction start times.

2. The method of claim 1, wherein the outputting of the updated auction start times includes:
providing the updated auction start times to a display.

3. The method of claim 1, wherein the outputting of the updated auction start times includes:
providing the auction start time to mobile devices of buyers.

4. The method of claim 1, further comprising:
determining locations of the plurality of vehicles in relation to a map of auction lanes, and wherein the outputting includes outputting the determined locations of the plurality of the vehicles in relation to the map.

5. The method of claim 1, further comprising:
receiving acceleration data from one of the plurality of vehicles; and
analyzing the received acceleration data to generate a report relating to the acceleration data, the report indicating whether the acceleration data indicates abnormal operation of the one of the plurality of vehicles.

6. The method of claim 1, wherein the analyzing of the received acceleration data includes analyzing the acceleration data, using one or more previous determined models, to determine a suspension metric indicating a quality of a suspension system of the one of the plurality of vehicles.

7. The method of claim 1, further comprising:
receiving audio data from one of the plurality of vehicles; and
analyzing the received audio data to generate a report relating to the audio data, the report including an audio metric indicating a quality of engine sounds of the one of the plurality of vehicles.

8. The method of claim 1, wherein the receiving of the location information includes receiving the location information from devices connected to an on-board diagnostic (OBD) port associated with the plurality of vehicles.

9. The method of claim 8, wherein the location information is received from a mesh network associated with the plurality of vehicles.

10. The method of claim 1, further comprising:
receiving a request to provide an alert, for one of the plurality of vehicles, relating to an auction state of the one of the plurality of vehicles; and
generating one or more alerts based on the auction state of the one of the plurality of vehicles.

11. A server device comprising:
a non-transitory computer-readable medium to store processor-executable instructions; and
one or more processors to execute the processor-executable instructions to:
receive location information from a plurality of vehicles;
determine, based on the location information, places of the plurality of vehicles in a plurality of auction lanes;
calculate, based on the determined places of the plurality of vehicles, updates to auction start times associated with at least one of the plurality of vehicles in the plurality of auction lanes; and
output the updated auction start times.

12. The server device of claim 11, wherein the processor-executable instructions further include instructions, that when executed by the one or more processors, cause the one or more processors to:
determine locations of the plurality of vehicles in relation to a map of auction lanes, and wherein the outputting includes outputting the determined locations of the plurality of the vehicles in relation to the map.

13. The server device of claim 11, wherein the processor-executable instructions further include instructions, that when executed by the one or more processors, cause the one or more processors to:
receive audio data from one of the plurality of vehicles; and
analyze the received audio data to generate a report relating to the audio data, the report including an audio metric indicating a quality of engine sounds of the one of the plurality of vehicles.

14. The server device of claim 11, wherein the analyzing of the received acceleration data includes analyzing the acceleration data, using one or more previous determined models, to determine a suspension metric indicating a quality of a suspension system of the one of the plurality of vehicles.

15. The server device of claim 11, wherein the processor-executable instructions further include instructions, that when executed by the one or more processors, cause the one or more processors to:
receive audio data from one of the plurality of vehicles; and
analyze the received audio data to generate a report relating to the audio data, the report indicating whether engine sounds including an audio metric indicating a quality of engine sounds of the plurality of vehicles.

16. The server device of claim 11, wherein the receiving of the location information includes receiving the location information from devices connected to an on-board diagnostic (OBD) port associated with the plurality of vehicles.

17. The server device of claim 11, wherein the processor-executable instructions further include instructions, that when executed by the one or more processors, cause the one or more processors to:
receive a request to provide an alert, for one of the plurality of vehicles, relating to an auction state of the one of the plurality of vehicles; and
generate alerts based on the auction state of the one of the plurality of vehicles.

18. A method, implemented by one or more computing devices, comprising:
receiving, by the one or more computing devices, sensor data from sensors of a plurality of in-vehicle devices installed in vehicles;
analyzing, by the one or more computing devices, the sensor data to determine models that describe, for a particular vehicle make, model, and year, whether the sensor data indicates normal operation of a vehicle of the particular make, model, and year;
receiving, by the one or more computing devices, a sample of the sensor data from a first vehicle;
generating, by the one or more computing devices and based on the sample of the sensor data and the determined models, a report indicating whether operation of the first vehicle, with respect to the sample of the sensor data, is consistent with normal operation of the vehicle; and
outputting the report.

19. The method of claim 18, wherein the sensor data includes audio data recorded by the in-vehicle device.

20. The method of claim 18, wherein the sensor data includes acceleration data recorded by the in-vehicle device.

21. The method of claim 18, further comprising:
receiving diagnostic information, from the in-vehicle devices, relating to diagnostic information, received by the in-vehicle devices in a time period corresponding to the received sensor data, from an on-board diagnostic (OBD) ports of the vehicles.
